(19) United States
(12) Patent Application Publication
(10) Pub. No.: US 2008/0147630 A1
(43) Pub. Date: Jun. 19, 2008

(54) RECOMMENDER AND PAYMENT METHODS FOR RECRUITMENT

(76) Inventor: Kaiyi Chu, Forest Hills, NY (US)

Correspondence Address: J.C. Patents, 4 Venture, Suite 250, Irvine, CA, 92618, US

(21) Appl. No.: 11/553,907

(22) Filed: Oct. 27, 2006

(51) Int. Cl. G06F 17/30

(52) U.S. Cl. 707/5

(57) ABSTRACT

A job recommender method and a candidate recommender method apply two common classification techniques (K-nearest Neighbors and Classification Tree) to generate job recommendations for job seekers and candidate recommendations for employers. The invention further utilizes a matching algorithm to calculate the match degree between a particular job and a particular candidate, and to create an order of priority and relevancy for users. In addition, the matching algorithm enables a pay-for-performance payment method, which charges employers for receiving qualified candidates. The recommender and payment methods and system of the invention is accessible via a network, such a local area network, a wide area network, or the Internet.

### BACKGROUND OF THE INVENTION

1. Technical Field of the Invention

The invention relates to two computer implemented recommender methods for recommending jobs to job seekers and candidates for employers. More particularly, the invention utilizes classification techniques to generate recommendations and implements a matching algorithm to create an order of priority and relevancy on recommendations, and enables a pay-for-performance payment method which charges employers for receiving qualified candidates by using the recommender methods. The recommender and payment methods and system of the invention are accessible within a network, such a local area network, a wide area network, or the Internet.

2. Description of the Related Technology

Recommender systems have become an important research area since the appearance of the first papers on collaborative filtering in the mid-1990s. Recommender systems help users to deal with information overload and provide personalized recommendations, content, and services. A typical application is recommending books, CDs, and other products at Amazon.com. The current generation of recommender methods are classified as collaborative, content-based, and hybrids recommender methods. Collaborative recommender methods try to predict the utility of items for a particular user based on the items previously rated by other users. In content-based recommendation methods, the utility of a particular item for a particular user is estimated based on the utilities assigned by the same user to other items that are “similar” to that item. A hybrid approach combines collaborative and content-based methods to avoid certain limitations of content-based and collaborative systems.

K-nearest Neighbors and Classification Tree are two common classification techniques which are widely used in recommender systems. K-nearest Neighbors is an instance-based learning algorithm where the unknown attribute value of an instance is predicted based on majority of K-nearest neighbor category. First, every instance is represented with a set of numerical attributes. The “similarity” is defined in terms of the Euclidean distance between two examples and closer distance means more similarly. The Euclidean distance between X=(x₁, x₂, x₃, . . . xₙ) and Y=(y₁, y₂, y₃, . . . yₙ) is defined as: D(X, Y)=square root of Σ(xᵢ-yᵢ)². Second, a fixed number of most similarly old instances to a new instance are selected according to the Euclidean distance. Third, those selected similarly instances are analyzed to determine what value of a particular attribute is the most common among the set. Finally, the most common value is assigned to the same attribute of the new instance.

Classification Tree is a method to split the whole population into increasingly purer sub groups that contain predominantly similar instances. The existing data are separated as training data and testing data. A tree is constructed by partitioning the training data with different attributes. After the training data are split into different subsets, the splits are ranked and the best one is chosen. Under the subsets that are chosen, such a partitioning process is repeated until no more good splits are possible. Although it is not possible to create completely pure subsets, it is possible to create purer subsets. The accuracy of the classification rule is estimated by applying the rule on the testing data. If the percentage of test set samples that are correctly classified by the rule is acceptable, the rule is considered effective. By identifying the class where an instance belongs to, the unknown attribute value of an instance can be predicted based on the information contained by the class.

For more information, The Book “Data Mining Techniques” (ISBN:0-471-47064-3) by Michael J. A. Berry and Gordon S. Linoff introduces the two techniques in Chapter 6 and Chapter 11 separately. Many software, such as SPSS and XLMiner, have functions to operate K-nearest Neighbors and Classification Tree. However, those two classification techniques are not formerly applied in online recruitment industry so far.

### BACKGROUND OF THE INVENTION

In the mid 1990s, mass adoption of the online recruiting market began to occur. Changing technology, the Internet in particular, has had a dramatic impact on the employment services market as the Internet has revolutionized the process of matching prospective candidates with job openings. Although the online recruitment industry had suffered from the economic downturn of 2001-2003 which directly led to the domination of three major players: Monster, CareerBuilder and Yahoo! HotJobs, the industry has entered a new growth phase since 2003. According to industry experts, 96% of Fortune 500 companies now use some sort of online recruitment process. Industry compound annual growth rate through 2008 is expected to be at around 22%.

One advantage of the e-recruiting is convenience of the job posting and hunting process. The traditional job websites enable companies and individuals to expand geographical reach and to have access to dramatically improved communication tools. They provide search engines based on single or multi criteria to communicate between a database of job postings and a database of personal information and list all searching results to candidates/recruiters. While this multi-step filtering process is widely used by hundreds of job web sites, the disadvantages of it are standing out as the job web sites are overloaded by millions of job postings and resumes. According to Data-Monitor's analysis report, Monster has often been accused of disappointing its clients who claim that many of the applicants referred by Monster weren't a good match. Employers have had the experience of weeding through hundreds of poorly tailored resumes sent to them by inexperienced job seekers by Monster. On the other hand, job seekers usually get hundreds or thousands of searching results and have to spend a lot of time to dig suitable opportunities. Therefore, a better method of matching an individual with his qualifications is needed.

There has been much work done on developing new matching approaches in this industry. Three major trends are improved searching engine, keyword pattern research, and recommender models.

Improved searching engine, basically still a multi-step filtering process, focus on the determination of job qualification criterion and the procedure to filter matched candidates. U.S. Pat. No. 5,832,497 discloses a system that provide an iterative database query engine to permit an initial search and at least one subsequent search where subsequent search operates on the results of first search and any previous search. U.S. Pat. No. 5,164,897 discloses an automated method for selecting personnel which includes the steps of selecting employees having qualifications matching job criteria. U.S. Pat. No. 6,385,620 discloses a candidate web engine to present a candidate survey form to a client of the network, and a candidate mapping engine operable to receive the candidate qualification data from the candidate web engine and to generate at least one candidate identifier in response to parsing the candidate qualification data. U.S. Pat. No. 7,080,057 discloses an automated employee selection system which predicts a desired job performance criterion for new applications and uses a variety of techniques, such as pre-hire and post-hire information, to provide information for assisting in selection of employees. U.S. Publication No. 2002/0026452 discloses a website where potential candidates interested in a particular matching position are presented with an online exam to eliminate unqualified candidates. U.S. Publication No. 2005/0228709 discloses an automated job placement system which the match process uses screening and pre-qualification procedures.

The keyword pattern research employs artificially intelligent systems to analyze resumes and extracting information related to job categorization. U.S. Pat. No. 5,197,004 discloses a method and apparatus for automatically selecting the job category or categories within which an applicant should be placed using only the applicant's resume. Simplyhired.com is currently providing “job suggestions” service which suggests job opportunities based on the keyword pattern analysis on jobs that are already rated by job seekers.

Recommendation models are much more underdeveloped among three matching approaches. U.S. Publication No. 2006/0178896 discloses a system which matches candidates and job positions based on personalities and basic qualifications. U.S. Publication No. 2005/0080657 introduces an n-dimensional concept space to map a point for a job and a point for a candidate. The suitable concept score for a job is calculated as: Concept Score=length of service×recency factor+related skills. The distance between a candidate and a job, for a 3-dimensional space, is calculated as: distance=√.sup.3 (dx.sup.3+dy.sup.3+dz.sup.3). Therefore, those candidates close to the desired candidate criteria in the concept space can be designed as matches for the desired candidate criteria. Market10.com claims a patent pending matching technology based on 10 dimensions of a good job fit. By collecting information about work environment, travel, industry, work authorization, target income, skills, education, years experience, location and benefits, it ranked job opportunities for a particular candidate.

However, there still remains significant room for improvement in the matching process. The most obviously disadvantage of the searching system and keyword pattern research is, although the quality of filtering results are greatly improved, those two approaches failed to establish an order of priority and relevancy for both candidates and employers. Some solutions involved a rating mechanism which requires candidates rate the jobs they viewed. The lack of clear criterion for rating makes the rating results highly subjective and unusable in generating highly accurate matching criteria. Some solutions rank jobs for candidates through different technologies, but the technologies produce ratings that are based on a limited understanding of candidates and jobs and do not take full advantage of the information in the user transactional histories and other available data.

### SUMMARY OF THE INVENTION

The present invention formally and creatively applies K-nearest Neighbors and Classification Tree for recruitment purpose, especially for online recruitment. The invention provides various approaches to generate a potential job pool for a particular candidate and a potential candidate pool for a particular job position. For example, the invention assumes that job-seekers/employers vote for jobs/candidates by behaviors (applied or not, accepted or not). The recommender methods described in the invention can compare an unviewed job/candidate with those viewed jobs/candidates to predict whether the unviewed job/candidate is possible to be applied/accepted. Another example, the invention can classify all candidates based on subjective attributes and generate the classification rule. Then the invention can identify the class which a particular candidate belongs to. By analyzing the jobs that other candidates in the same class applied for, the invention can generate a potential job pool for the candidate.

Moreover, the invention uses a matching algorithm to calculate the match degree between a particular job and a particular candidate. The matching algorithm defines the match degree as the weighted value of job match degree, company match degree, and personality match degree. Job match involves the job preference of a particular candidate and the job attributes of a particular job position. Company match involves the company preference of a particular candidate and the company background of a particular employer. Personality match involves the personalities a particular candidate possesses and the personalities a particular employer desires. Because not all job postings have a clear qualification for all personal attributes, special rules for scaling are applied to ensure the match degrees for different jobs or different candidates are comparable and meaningful. The weights for the three dimensions are set by the system or by the employer user. The advantages of the matching algorithm are 1) comprehensiveness, which means the result reflects all major interactive attributes, 2) comparability, which means the results among different jobs or candidates are comparable, and 3) flexibility, which means the weights for the three dimensions are adjustable to satisfy various requirements from employers.

The invention also includes a pay-for-performance payment method which only charged employers for candidates with match degrees over a minimal requirement. The recommender method is fairly paid for providing right candidates or jobs. The scientific matching algorithm is the solid grounding for the payment method.

The aim of the invention is to make the job searching and hiring process more efficient. Users of the system only need to input basic and straightforward information about their attributes, preference and requirements, and the system takes full advantage of their transactional histories (i.e. jobs unviewed, viewed but not applied, or viewed and applied by a particular job seeker, candidates unviewed, viewed but not accepted, or viewed and accepted by a particular employer) to develop comprehensive understanding of candidates and employers. Different approaches to generate a potential job/candidate pool provided by the invention can satisfy various demands from candidates and employers. For example, if a candidate is not sure about his/her career path, the jobs applied by other candidates with similar background and preference can by used for reference. Therefore, the invention can greatly improve the accuracy and relevancy of jobs/candidates recommendations.

Another objective of the invention is to make the rating of different jobs or candidates comparable and meaningful. The rating should comprehensively reflect the fitness of a candidate to a job position. With an order of priority, the candidates or employers can effectively shorten the time length of job searching or candidate hunting process.

Another objective of the invention is to improve economic efficiency of hiring process for employers. The traditional fee structure of job web sites is pay-per-posting which totally ignores the yield factor. Some websites charge per individual employed, a method which unfairly determines the productivity of job web sites because job web sites can not and should not guarantee that employers will definitely hire someone from those websites. The main function of job web sites is to offer a match between potential employees and employers. With the reasonable matching algorithm to correctly calculate the match degree, pay-for-performance empowers a healthier business relationship in the online recruitment industry.

The invention develops better recommending models and a new business method. The invention includes the novel and nonobvious features, method steps, and acts alone and in various combinations and sub-combinations with one another as set forth in the claims. The invention is not limited to a particular combination or sub-combination thereof. Technology, methods, and algorithm from one or more of any of the examples can be incorporated into any of the other examples.

### BRIEF DESCRIPTION OF THE DRAWINGS

FIG. 1 is a flowchart showing an exemplary online recommender system which employs recommender methods described in the invention.

FIG. 2 is a flowchart showing an exemplary method for using K-nearest Neighbors to generate a potential job pool.

FIG. 3 is a flowchart showing an exemplary method for using K-nearest Neighbors to generate a potential candidate pool.

FIG. 4 is a diagram showing an exemplary classification tree of candidates.

FIG. 5 is a diagram showing an exemplary classification tree of employers.

FIG. 6 is a diagram showing an exemplary classification tree of jobs.

FIG. 7 is a block diagram showing an exemplary matching algorithm.

FIG. 8 is a block diagram showing an exemplary pay-for-performance method.

FIG. 9 is a block diagram showing an exemplary process for a candidate to use the online recommender system which employs recommender methods described in the invention.

FIG. 10 is a block diagram showing an exemplary process for an employer to use the online recommender system which employs recommender methods and pay-for-performance method described in the invention.

### DETAILED DESCRIPTION OF THE EXEMPLARY EMBODIMENTS

### EXAMPLE 1

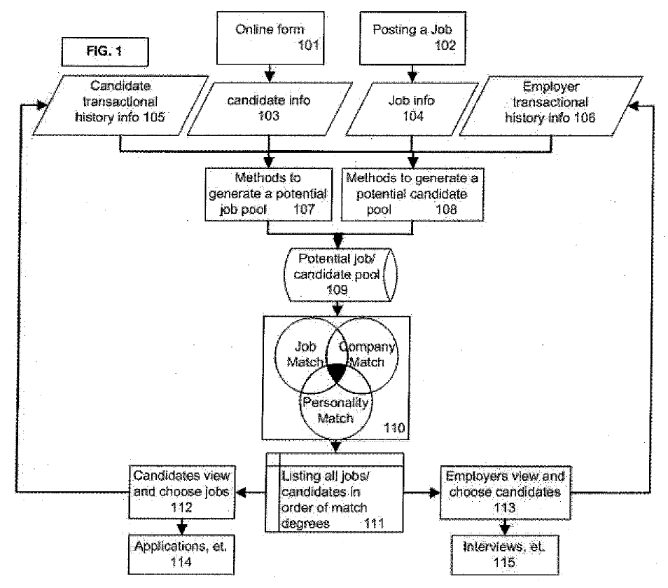

FIG. 1 is a flowchart showing an exemplary online recommender system which employs recommender methods described in the invention. It is to be understood that the system can be implemented using general purpose computer hardware as a network site. Any number of commercially available Internet communications, database management and data mining software may be utilized to implement the invention.

According to the invention, the system collects both candidate information 103 from online forms 101 filled by candidates and job information 104 from job postings 102 published by employers. Together with candidate transactional history information 105 (which contains information such as jobs unviewed, viewed but not applied, and viewed and applied by a particular candidate) and employer transactional history information 106 (which contains information such as candidates unviewed, viewed but not accepted, and viewed and accepted by a particular employer), candidate information and job information are analyzed at step 108 and step 107 through various methods, such as K-nearest Neighbors and Classification Tree, to generate a potential job or candidate pool 109. The matching algorithm 110 is operated to get the match degree between a candidate and a job. All jobs or candidates in the pool are then listed in order of match degrees at step 111. The system further enables candidates to review and apply jobs (steps 112 and 114) and enables employers to review and accept candidates (steps 113 and 115).

### EXAMPLE 2

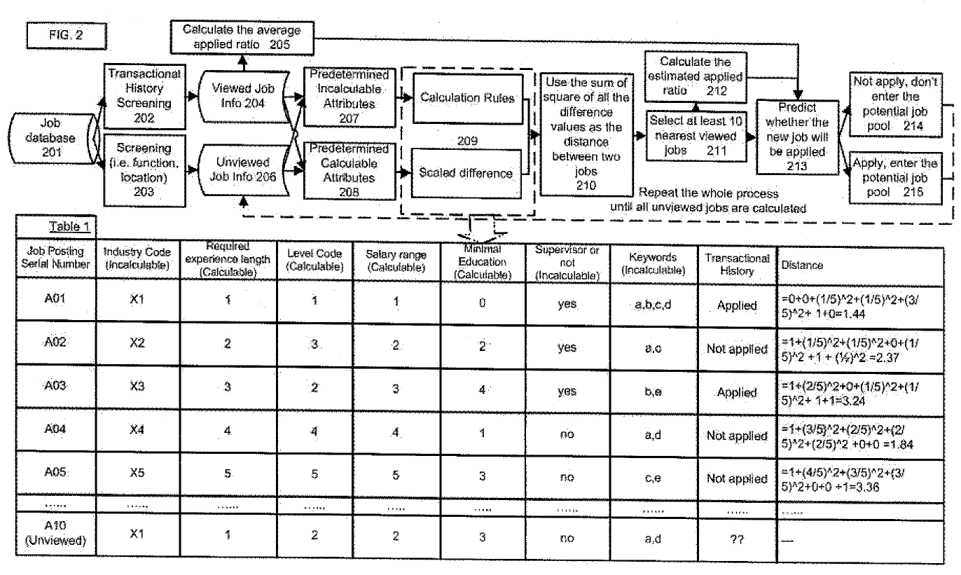

FIG. 2 is a flowchart showing an exemplary method for using K-nearest Neighbors to generate a potential job pool. In the example, a particular candidate requests job recommendations using method described below. The system first searches all jobs in a job database 201 by means of transactional history screening 202 to pick out jobs viewed by the same candidate requesting job recommendation to generate viewed job information 204, and calculate the average applied ratio 205 (average applied ratio=number of jobs applied by the candidate/number of jobs viewed by the candidate). The system then filters all unviewed jobs at a screening step 203 by some predetermined simple criteria such as locations and job functions to narrow down the scale of operation so as to generate unviewed job information 206. Then every unviewed job in the unviewed job information 206 is compared with every viewed job in the viewed job information 204 according to selected incalculable attributes 207 and calculable attributes 208, and the similarity between two jobs is calculated.

Because the job possesses some non-numerical attributes, the typical K-nearest Neighbors algorithm described in “Description of the Related Technology” part is modified here to be applicable. All selected attributes are classified as calculable and incalculable data. For the calculable data, such as “education level”, the difference between two values is meaningful and comparable. For the incalculable data, such as employer's “industry code”, the difference between two values is meaningless and incomparable. All attributes are also classified as single-choice and multi-choice data. Moreover, all calculable attributes are single-choice and categorized data. Therefore, several calculation rules are applied based on the data type of selected attributes:

1) For incalculable single-choice attribute A, Aₓ=(aₓ) and A_{y}=(a_{y}). The distance between Aₓ and A_{y} is defined as: d_{(Ax,Ay)}=0 if aₓ=a_{y}; d_{(Ax}→_{Ay)}=1 if aₓ≠a_{y}.

2) For incalculable multi-choice attribute B, Bₓ=(b_{x1,} b_{x2,} b_{x3,} . . . bₓₘ) and B_{y}=(b_{y1,} b_{y2,} b_{y3,} . . . b_{yn}), the subset Z={Z₁, Z₂, Z₃, . . . Zᵢ} includes all common items between Bₓ and B_{y}. The distance of Bₓ to B_{y} is defined as: d_{(Bx}→_{By)}=i/n. And the distance of B_{y} to Bₓ is defined as: d_{(By}→_{Bx)}=i/m.

3) For calculable, single-choice and categorized attribute C, Cₓ=(cₓ) and C_{y}=(c_{y}). The category range of C is r. The distance between Cₓ and C_{y} is defined as: d_{(Cx,} c_{y)}=|x-y|/r.

4) The distance of job X to job Y is defined as: D_{(X}→_{Y)}=Σ[d_{(Ax, Ay)}²+d_{(Bx}→B_{y)}²+d_{(Cx,} c_{y)}²]. And the distance of job Y to job X is defined as: D_{(Y}→x₎=Σ[d_{(Ax, Ay)}²+d_{(By}→_{Bx)}²+d_{(Cx,} c_{y)}²].

5) The distance range for all attributes is 0 to 1, and the distance range for two jobs with k number of attributes is 0 to k.

Table 1 in FIG. 2 shows a simple example of distance calculation. In the example, the category range for all calculable data is 5. For an incalculable single-choice attribute as “industry code”, if the value of an unviewed job A10 is the same as that of a viewed job, the distance is 0, or it is 1. For an incalculable multi-choice attribute as “keywords”, job A10 and job A02 have one common key word “a” and job A10 has two key words “a, d”, so the distance of job A02 to job A10 is 0.5. For a calculable attribute as required experience length, distance between job A10 and job A03 is calculated as: |1−3|/5=2/5. Finally, the distance between two jobs is the sum of square of distance values for all selected attributes. For example, the distance between job A10 and job A03 is calculated as: 1+(2/5)²+0+(1/5)²+(1/5)²+1+1=3.24.

After the distances between an unviewed job and every viewed job are calculated, the system selects a fixed number of nearest viewed jobs to the unviewed job (where the nearest viewed jobs means the jobs having shortest distance to the unviewed job), for example, 10 or 20, which number can be determined by the system designer, and calculates the estimated applied ratio 212 (estimated applied ratio=number of nearest jobs applied by the candidate/number of selected nearest viewed jobs). If the estimated applied ratio is not less than the average applied ratio, the unviewed job is highly possible to be applied by the candidate and enters the potential job pool 215. If not, the unviewed job is abandoned 214. The whole process is repeated for every unviewed job until a potential job pool is completed.

### EXAMPLE 3

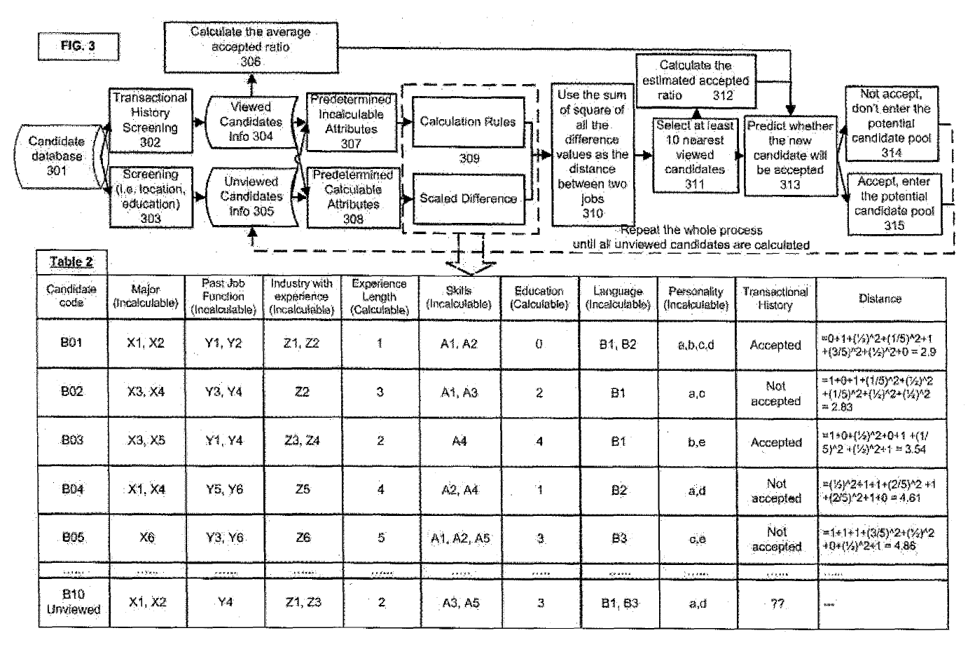

FIG. 3 is a flowchart showing an exemplary method for using K-nearest Neighbors to generate a potential candidate pool. In the example, a particular employer requests for candidate recommendations for a particular job position using method described below. The system first searches all candidates in a candidate database 301 by means of transactional history screening 302 to pick out candidates viewed by the same employer requesting candidate recommendations to generate viewed job information 304, and calculate the average accepted ratio 306. The system then filters all unviewed candidates at a screening step 303 by some predetermined simple criteria such as locations and education to narrow down the scale of operation so as to generate unviewed candidates information 305. Every pro-screen unviewed candidate in unviewed candidate information 305 is compared with every viewed candidate according to selected incalculable attributes 307 and calculable attributes 308, and the similarity between two candidates is calculated.

Because the candidate possesses some non-numerical attributes, the typical K-nearest Neighbors algorithm described in “Description of the Related Technology” part is modified here to be applicable. All selected attributes are classified as calculable and incalculable data. For the calculable data, such as “experience length”, the difference between two values is meaningful and comparable. For the incalculable data, such as “major”, the difference between two values is meaningless and incomparable. All attributes are also classified as single-choice and multi-choice data. Moreover, all calculable attributes are single-choice and categorized data. Therefore, the same calculation rules described in EXAMPLE 2 are applied based on the data type of selected attributes.

Table 2 in FIG. 3 shows a simple example of distance calculation. In the example, the category range for all calculable data is 5. For an incalculable multi-choice attribute as “major”, candidate B10 and candidate B04 have one common major “X1” and candidate B10 has two majors, so the distance of candidate B04 to candidate B10 is 0.5. For a calculable attribute as “experience length”, the distance between B10 and B04 is calculated as: |2−4|/5=2/5. Finally, the distance between two candidates is the sum of square of distance values for all selected attributes. For example, the distance between candidate B10 and candidate B04 is calculated as: (½)²+1+1+(2/5)²+1+(2/5)²+1+0=4.61. The example doesn't include any incalculable single-choice attributes.

After the distances between an unviewed candidate and every viewed candidate are calculated, the system selects a fixed number of nearest viewed candidates to the unviewed candidate (where the nearest viewed candidates means the candidates having shortest distance to the unviewed candidate), and calculates the estimated accepted ratio 312 (estimated accepted ratio=number of nearest candidates accepted by the employer for the job/number of selected nearest candidates). The fixed number of the nearest viewed candidates can be determined by the system designer. If the estimated accepted ratio is not less than the average accepted ratio, the unviewed candidate is highly possible to be accepted for this job position and enters the potential candidate pool 315. If not, the unviewed candidate is abandoned 314. The whole process is repeated for every unviewed candidate until a potential candidate pool is completed.

### EXAMPLE 4

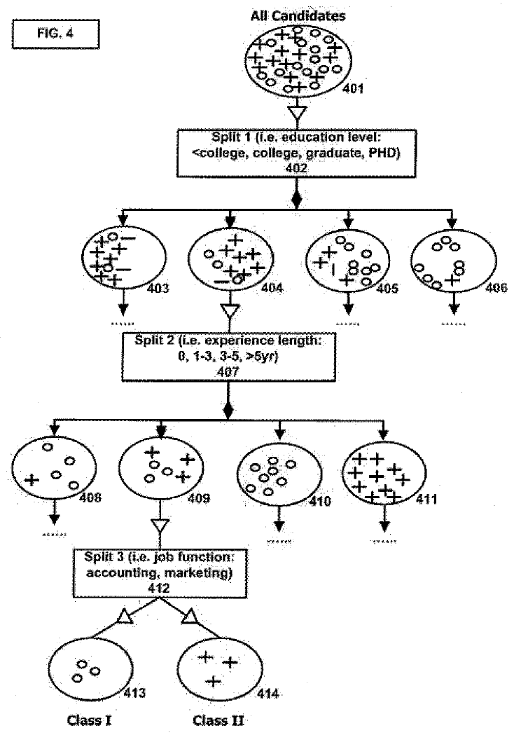

FIG. 4 is a diagram showing an exemplary classification tree of candidates. Such a classification tree can be utilized in method described below. In the example, the whole candidate population 401 is split by only three attributes, education level, experience length, and job function. If desirable, other attributes can also be used, such as major and salary level. The classification rule is read as: education level 402 (<college 403, college 404, graduate 405, and PHD 406) to experience length 407 (0 year 408, 1-3 years 409, 3-5 years 410, and >5 years 411) to job function 412 (accounting 413, marketing 414). To classify a new candidate, the node that the candidate belongs to is determined based on its values on those attributes.

The real classification rule can be automately generated by common data mining software such as SPSS and XLMiner only when the candidate database is built up. Because the population and individual information change frequently, the system analyzes and updates the classification rule periodically. Correspondingly, the class of a particular candidate may be also updated.

### EXAMPLE 5

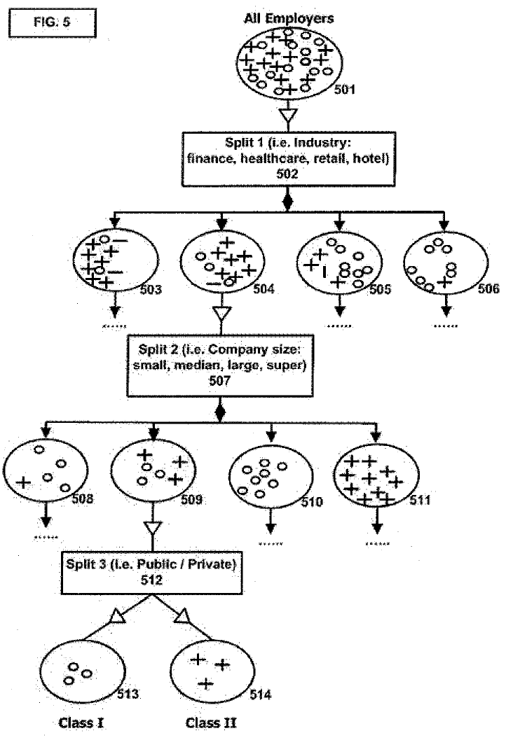

FIG. 5 is a diagram showing an exemplary classification tree of employers. Such a classification tree can be applied in method described below. In the example, the whole employer population 501 is split by only three attributes: industry, company size, and public/private. If desirable other attributes can also be used, such as company type. The classification rule is read as: industry 502 (finance 503, healthcare 504, retail 505, and hotel 506) to company size 507 (small 508, median 509, large 510, and super 511) to public/private 512 (public 513, private 514). To classify a new employer, the node that the employer belongs to is determined based on its values on those attributes.

The mechanism to generate the classification tree is the same as what is described in example 4. The real classification rule can be automatically generated by common data mining software such as SPSS and XLMiner only when the employer database is built up. Because the population and individual information change frequently, the system analyzes and updates the classification rule periodically. Correspondingly, the class of a particular employer may be also updated.

### EXAMPLE 6

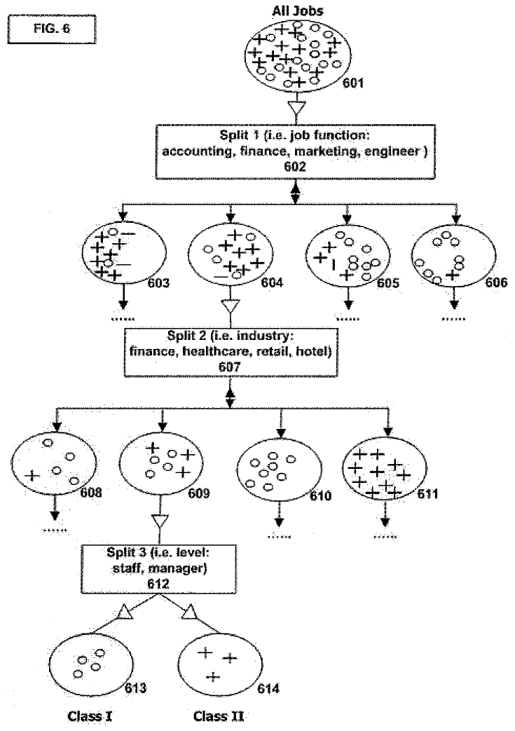

FIG. 6 is a diagram showing an exemplary classification tree of jobs. Such a classification tree can be applied in method described below. In the example, the whole job population 601 is split by only three attributes: job function, industry, and level. If desirable, other attributes can also be used such as salary range and education level. The classification rule is read as: job function 602 (accounting 603, finance 604, marketing 605, and engineer 606) to industry 607 (finance 608, healthcare 609, retail 610, and hotel 611) to level 612 (staff 613, manager 614). To classify a new job, the node that the job belongs to is determined based on its values on those attributes.

The mechanism to generate the classification tree is the same as what is described in example 4. The real classification rule can be automated generated by common data mining software such as SPSS and XLMiner only when the job database is built up. Because the population and individual information change frequently, the system analyzes and updates the classification rule periodically. Correspondingly, the class of a particular job may be also updated.

### EXAMPLE 7

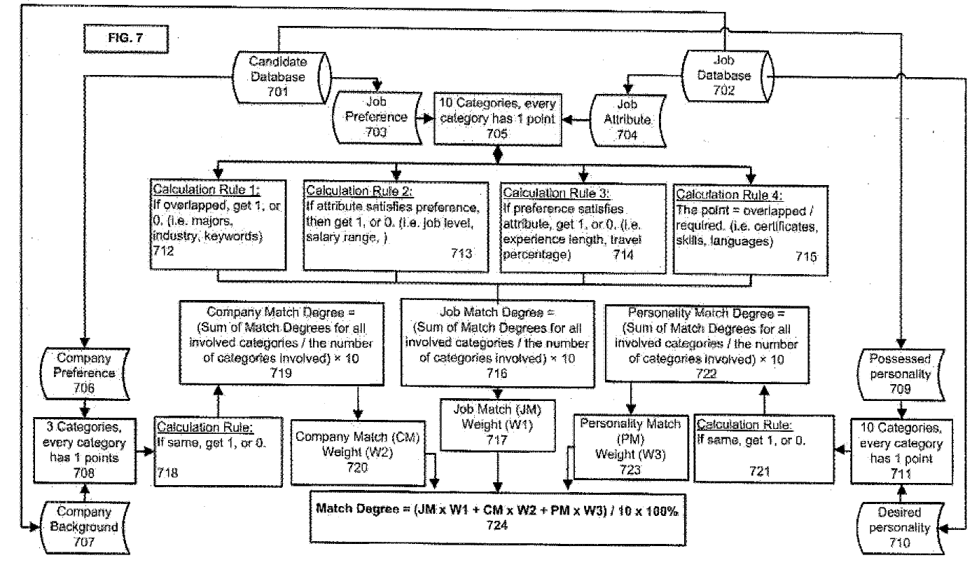

FIG. 7 is a block diagram showing an exemplary matching algorithm. Both job information in a job database 702 and candidate information in a candidate database 701 are categorized as job match information (job preference 703 and job attribute 704), company match information (company preference 706 and company background 707), and personality match information (possessed personality 709 and desired personality 710). The job database 702 and the candidate database 701 can be generated with various conventional methods or a method described in the present invention. For example, the job database 702 and the candidate database 701 can be the potential job/candidate pool 109 of FIG. 1 generated by various methods described above. The example shown below creates various scenarios to illustrate the mechanism for running the algorithm. It should be recognized that the detailed embodiments are illustrative only and should not be taken as limiting the scope of the invention.

Job Match 718

Job match is the most complicated dimension due to the complexity of job match information. In the example, all job match information is classified as ten categories 705, including major, industry, job level, salary range, travel percentage, experience length, certificate, skill, language, and keyword. If desirable, the job match information can be classified in more or less than ten categories. Every category includes information both from job preference 703 and job attribute 704, and is assigned 1 point. For example, major category includes majors possessed by candidates and majors required by employers; salary range category includes salary code desired by candidates and salary code provided by employers. Different calculation rules are developed according to the nature of different categories.

i) Calculation Rule I 712: for a category such as major, industry, and keyword, if job preference and job attribute have overlapped information, the match degree for the category is 1; or it is 0. For example, a particular candidate looks for a job with keywords as “marketing, consulting”, if either of them appears in the keywords of a particular job position, keyword category gets 1 point. Another example, if the industry code of a particular employer is included in the industry codes preferred by a particular candidate, industry category gets 1 point.

ii) Calculation Rule II 713: for a category such as job level and salary range, if the job attribute matches the job preference, the match degree for the category is 1; or it is 0. For example, the salary range category includes five classes, including 0 (N/A), 1 (less than $40,000 per year), 2 ($40,000-60,000 per year), 3 ($60,000-80,000 per year), 4 ($80,000-100,000 per year), and 5 (more than $100,000 per year). If salary range provided by a particular job is 4 and salary range desired by a particular candidate is 3, the match degree of salary range category is 1.

iii) Calculation Rule III 714: for a category such as experience length and travel percentage, if the job preference matches the job attribute, the match degree for the category is 1; or it is 0. For example, if a particular job requires at least 3 years working experience and the candidates has 5 years, the score for this category is 1.

iv) Calculation Rule IV 715: for a category such as certificates, skills, and languages, the match degree for the category is defined as:

Match Degree for a particular category=(Number of required certificates/skills/languages possessed by candidates)/(Number of required certificates/skills/languages)

For example, a particular job position requires three certificates, including CPA, CFA, and OFFICE EXPERT, and a particular candidate possesses only two of them, the score for certificate category is 2/3. Another example, a particular job position requires three skills, including computer, writing, and communication, and a particular candidate possess all of them, the score for skills category is 1.

In step 716, match degrees for job match dimension is calculated as:

Job Match Degree=(Sum of Match Degrees for all involved categories/the number of categories involved)×10

where “involved” means a particular category is required or mentioned by either the candidate or the job. For example, a sales job may only require good communication skill, and a marketing job may prefer MBA (major), 5 years experience (experience length), and three skills (writing, computer, and communication). Assume a particular candidate gets 1 point in major, 1 point in experience length, and 2/3 point in skills, the Job Match Degree is [(5/3)/3]×10=50/9. The advantage of this match formula is that match degrees among different jobs or candidates will be comparable.

Company Match 720

In the example, all company match information is classified as three categories 708, including company size, company type, and public/private. If desirable, the company match information can be classified as more or less than three categories. Other categories such as location can also be used. Every category includes information both from company preference 706 and company background 707, and is assigned 1 points.

For all three categories in company match, if the information from company preference is the same as that from company background, the match degree is 1; if not, it is 0. In step 719, match degrees for company match dimension is calculated as:

Company Match Degree=(Sum of Match Degrees for all involved categories/the number of categories involved)×10

where “involved” means a particular category is required or mentioned by either the candidate or the job.

Personality Match 723

In the example, 10 personalities, including creative, cooperative, detail-oriented, expressive, leadership, multi-tasks management, patient, risk taker, sociable, and self-motivated, are preset and every one is assigned 1 point. For all categories in personality match, if the information from possessed personality 709 is the same as that from desired personality 710, the match degree is 1; if not, it is 0. In step 722, match degrees for personality match dimension is calculated as:

Company Match Degree=(Sum of Match Degrees for all involved categories/the number of categories involved)×10

where “involved” means a particular category is required or mentioned by either the candidate or the job. For example, a particular sales job requires three personalities: sociable, expressive, and self-motivated, and a particular candidate possesses two of them, the scaled personality match degree is (2/3)×10=20/3.

Weighted Match Degree (%) 724

With predetermined weights for the three dimensions, the overall match degree is calculated as:

Match Degree=[(Job Match Degree×Weight of Job Match+Company Match Degree×Weight of Company Match+Personality Match Degree×Weight of Personality Match)/(the max number of categories in each dimension)]×100%,

where Weight of Job Match+Weight of Company Match+Weight of Personality Match=1, and each of Weight of Job Match, Weight of Company Match, and Weight of Personality Match is a number in the range from 0 to 1. In the present example, the max number of categories in each dimension is 10. While the system has default weights, the employers can adjust the weight for every dimension to reflect the preference for ideal candidates. For example, if the three dimensions (Job Match Degree, Company Match Degree, and Personality Match Degree) are equally weighted, then Weight of Job Match=Weight of Company Match=Weight of Personality Match=1/3. If one dimension need not be considered, the weight of that dimension can be set to 0.

The above example describes an overall match degree that includes job match, company match, and personality match, or three dimensions. However, the present invention is not limited to an overall match degree with three dimensions. More than three dimensions can be used in the overall match degree. Similarly, for an overall match degree with N dimensions and each dimension having equal to or less than M categories, the overall match degree is calculated as follows:

Match Degree=[(Match Degree for 1^{st} dimension×Weight of 1^{st} dimension+Match Degree for 2^{nd} dimension×Weight of 2^{nd} dimension+ . . . +Match Degree for N^{th} dimension×Weight of N^{th} dimension)/M]×100%;

where the sum of Weights of all dimensions is 1, and each of Weight is a number in the range from 0 to 1, and the match degree for each dimension is defined as:

Match Degree for 1^{st} dimension=(Sum of Match Degrees for all involved categories within 1^{st} dimension/the number of categories involved within 1^{st} dimension)×M

where the match degree for each category is in the range from 0 to 1, and “involved” means a particular category is required or mentioned by either the candidate or the job, and every category includes both candidate information and job information, and the match degree for each dimension is a number in the range from 0 to M.

### EXAMPLE 8

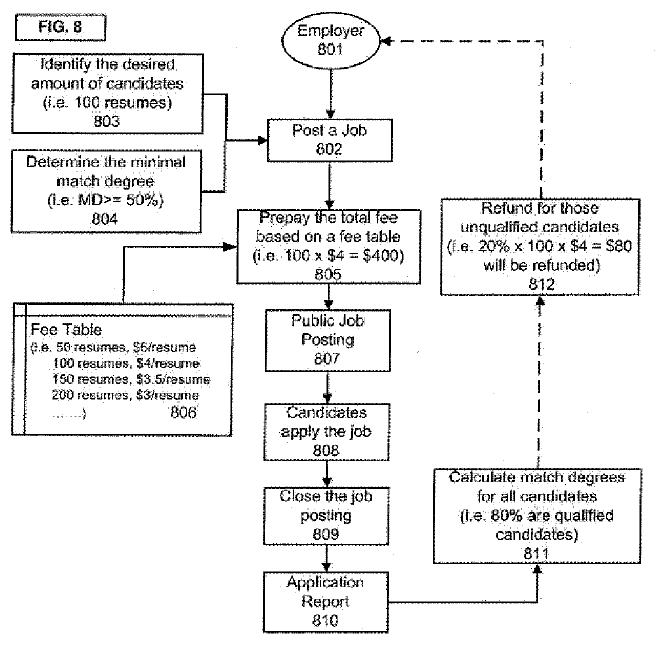

FIG. 8 is a block diagram showing an exemplary system for the pay-for-performance payment method. When posting a job on the online system, a particular employer 801 requires to identify the desired amount of candidates 803 and to determine the minimal Match Degree (MD) 804. The system employs a fee table 806 to determine the total fee required for the job posting. The employer prepays the total fee and publishes the job posting. The employer can close the job posting 808 as he wishes and view the application report 810 provided by the system. Match Degree (MD) of all candidates applied for the job are calculated and the employer may request refund for those candidates who fail to meet the minimal Match Degree. Therefore, the system only charges those qualified candidates. For example, a particular employer requires 100 candidates and the minimal Match Degree is set as 50%. According to the sample fee table, the total fee is 100×$4=$400. Assume 100 candidates submit the application and only 80% of them meet the criteria, the system will refund 100×20%×$4 $80 to the employer.

### EXAMPLE 9

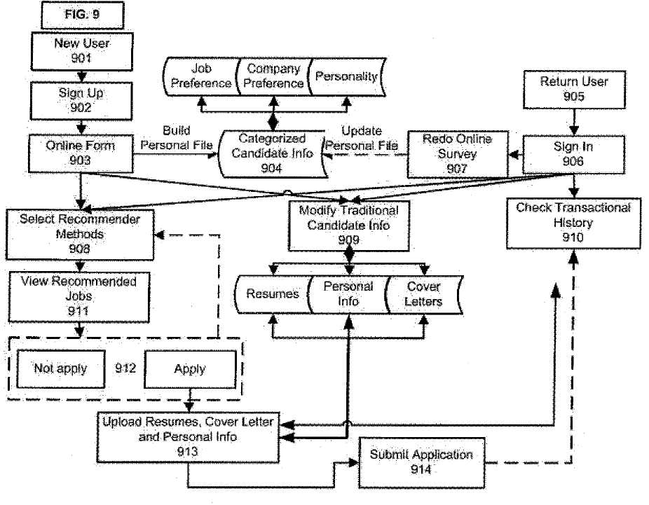

FIG. 9 is a block diagram showing an exemplary process for a candidate to use the online recommender system which employs recommender methods described in the invention. As a new user 901, the candidate first signs up the system 902 and completes an online form 903 to provide categorized candidate information 904. Then the candidate can select recommender methods 908 (i.e. K-nearest neighborhood, classification tree for candidates, classification tree for jobs, or classification tree for employers) or modify traditional candidate information 909 which is required for job application. If the candidate selects a recommender method, a potential job pool is generated and all jobs in the pool are listed in order of match degrees. The candidate chooses jobs to apply or reselects recommender methods to get different job recommendations. When applying jobs, traditional candidate information, such as resumes and cover letters, is uploaded to the system. Meanwhile, the candidate's operations on the system, such as updating personal information, selecting the recommender method, viewing jobs, and applying jobs, are stored in the transactional history information database. In particular, those recommended jobs have a status record including at least three statuses: unviewed, viewed but not applied, viewed and applied.

As a return user 905, the candidate can redo the online survey 907 and update the categorized candidate information which will directly affects the recommendation results. Then the candidate can choose to select recommender methods 908, modify old candidate information 909, or check transactional history 910. In 910, the candidate can review all viewed jobs, check application status, or apply those unapplied jobs.

### EXAMPLE 10

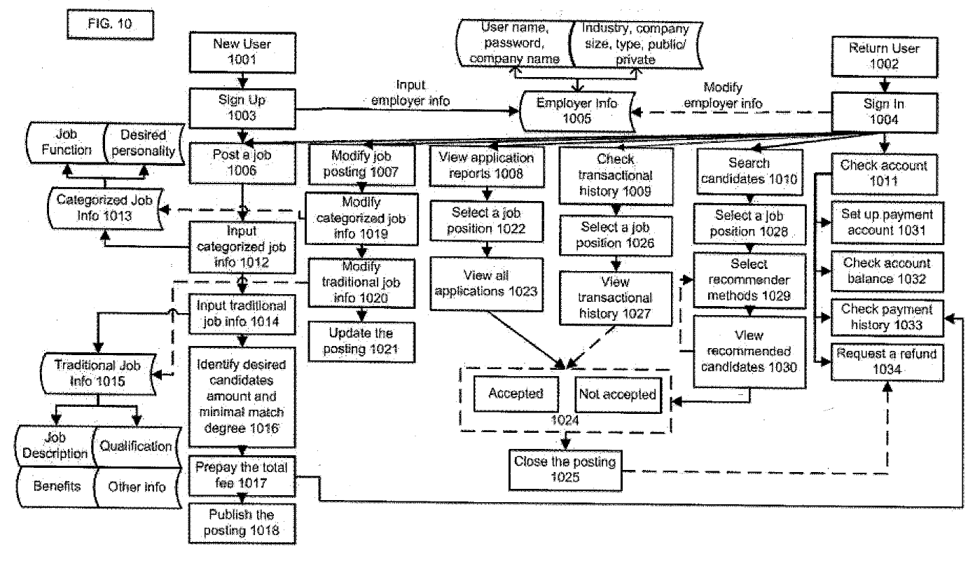

FIG. 10 is a block diagram showing an exemplary process for an employer to use the online recommender system which employs recommender methods and pay-for-performance method described in the invention. As a new user 1001, the employer first signs up the system 1003 and provides company information 1005. Then the employer can post a job 1006, a process including inputting categorized job information 1012, such as major, industry, job level, salary range, travel percentage, experience length, certificate, skill, language, and keyword as described above in job match and traditional job information 1014, which is usually some narrative paragraphs about the job position. After the employer identifies desired candidates amount and minimal match degree 1016 and prepays the total fee 1017, the job posting is published 1018.

As a return user 1002, the employer can choose to post a job 1006, modify a job posting 1007, view application reports 1008 which including the statistic on applications, check transactional history 1009 (i.e. the information about candidates who have been viewed/accepted/rejected), search candidates 1010, or check account 1011. In 1007, the employer can modify both categorized job information and traditional job information. In 1008, the employer selects a job position 1022 and views all application applied for the position 1023. In 1009, the employer can review all viewed candidates and update the application status for any candidates. In 1010, the employer selects an existing job posting and recommender methods (i.e. K-nearest neighborhood, classification tree for employers, classification tree for jobs), the system returns a potential candidate pool and all candidates in the pool are listed in order of match degrees. In 1011, the employer can set up payment account 1031, check its account balance on the system 1032, view the payment history 1033, or request a refund 1034 when a job posting is closed.

Alternatives

It should be understood that the processes or methods described herein are not limited to any particular type of computer apparatus, unless indicated otherwise. Various types of general purpose or specialized computer apparatus may be used with or perform operations in accordance with the teachings described herein. Elements of the illustrated embodiment shown in software may implement in hardware and vice versa. In view of the many possible embodiments to which the principles of the invention may be applied, it should be recognized that the detailed embodiments are illustrative only and should not be taken as limiting the scope of our invention. Rather, we claim as our invention all such embodiments as may come with the scope and spirit of the above claims and equivalents thereto.

I claim:

1. A recommender method for recommending jobs for a candidate, comprising the steps of:
collecting and storing candidate personal information for the candidate;
collecting and storing job information;
generating a potential job pool for the candidate;
calculating a match degree between the candidate and a job position within the potential job pool;
sorting job positions in the potential job pool according to their match degrees; and
recommending those job positions with a match degree higher than a predetermined minimal match degree.

2. The recommender method of claim 1, wherein the match degree with N dimensions and each dimension having equal to or less than M categories is defined as:
Match Degree=[(Match Degree for 1^{st} dimension×Weight of 1^{st} dimension+Match Degree for 2^{nd} dimension×Weight of 2^{nd} dimension+ . . . +Match Degree for N^{th} dimension×Weight of N^{th} dimension)/M]×100%;
where the sum of Weights of all dimensions is 1, and each Weight is a number in the range from 0 to 1.

3. The recommender method of claim 2, wherein the match degree for each dimension is defined as:
Match Degree for 1^{st} dimension=(Sum of Match Degrees for all involved categories within 1^{st} dimension/the number of categories involved within 1^{st} dimension)×M
where the match degree for each category is in the range from 0 to 1, and the match degree for each dimension is a number in the range from 0 to M.

4. The recommender method of claim 2, wherein N equals to 3, and the three dimensions are classified as: job match, company match, and personality match; the match degree is calculated as follows:
Match Degree=[(Job Match Degree×Weight of Job Match+Company Match Degree×Weight of Company Match+Personality Match Degree×Weight of Personality Match)/M]×100%.

5. The recommender method of claim 2, wherein M equals to 10; the job match is classified as ten categories: major, industry, job level, salary range, travel percentage, experience length, certificates, skills, languages, and keywords; the company match is classified as three categories: company size, company type, and public/private; the personality match is classified as ten categories: creative, cooperative, detail-oriented, expressive, leadership, multi-tasks management, patient, risk taker, sociable, and self-motivated; the match degree for each category is calculated as:
(i) for major, industry, and keywords categories, if candidate information and job information overlap, the match degree for the category is 1; or it is 0;
(ii) for job level and salary range categories, if job information matches candidate information, the match degree for the category is 1; otherwise it is 0;
(iii) for experience length and travel percentage categories, if candidate information matches job information, the match degree for the category is 1; or it is 0;
(iv) for certificates, skills, and languages categories, the match degree is defined as:
Match Degree for a particular category=(Number of required certificates/skills/languages possessed by candidates)/(Number of required certificates/skills/languages)
(v) for all company match categories and personality match categories, if candidate information is the same as job information, the match degree for the category is 1; or it is 0.

6. The recommender method of claim 1, wherein the step of generating the potential job pool uses K-nearest Neighbors method.

7. The recommender method of claim 1, wherein the step of generating the potential job pool comprises:
screening jobs in a job database to pick out jobs viewed by the candidate;
calculating an average applied ratio, wherein the average applied ratio equals to the ratio of number of jobs applied by the candidate over number of jobs viewed by the candidate;
calculating similarity between an unviewed job and the jobs viewed by the candidate according to job information in all categories;
selecting a predetermined number (K) of nearest viewed jobs to the unviewed job;
calculating an estimated applied ratio based on selected nearest viewed jobs, wherein the estimated applied ratio equals to the ratio of number of nearest jobs applied by the candidate over K;
including the unviewed job in the potential job pool if the estimated applied ratio is equal to or higher than the average applied ratio.

8. The recommender method of claim 7, wherein the similarity (D_{(X}→_{Y)}) of job X to job Y and the similarity (D_{(y}→x₎) of job Y to job X is calculated, respectively, as follows:
D_{(X}→_{Y)}=Σ[d_{(Ax, Ay)}²+d_{(Bx}→_{By)}²+d_{(Cx,} c_{y)}²] and
D_{(Y}→x₎=Σ[d_{(Ax, Ay)}²+d_{(By}→_{Bx)}²+d_{(Cx,} c_{y)}²]
where (i) for incalculable single-choice category A, Aₓ=(aₓ) and A_{y}=(a_{y}), the distance between Aₓ and A_{y} is defined as: d_{(Ax, Ay)}=0 if aₓ=a_{y}; d_{(Ax}→_{Ay)}=1 if aₓ≠a_{y};
(ii) for incalculable multi-choice category B, Bₓ=(b_{x1,} b_{x2,} b_{x3,} . . . bₓₘ) and B_{y}=(b_{y1,} b_{y2,} b_{y3,} . . . b_{yn}), the subset Z={z₁, z₂, z₃, . . . zᵢ} includes all common items between Bₓ and B_{y}, the distance of Bₓ to B_{y} is defined as: d_{(Bx}→_{By)}=i/n, and the distance of B_{y} to Bₓ is defined as: d_{(By}→_{Bx)}=i/m;
(iii) for calculable single-choice category C, Cx=(cₓ) and Cy=(c_{y}), the range of C is r, the distance between Cx and Cy is defined as: d(cₓ, c_{y})=|x−y|/r;
(iv) the distance range for all category is 0 to 1, and the distance range for two jobs with k number of categories is 0 to k.

9. The recommender method of claim 1, wherein the step of generating the potential job pool uses Classification Tree method.

10. The recommender method of claim 1, wherein the step of generating the potential job pool comprises:
classifying all candidates according to candidate information in all categories;
generating a classification rule which can be used to identify a particular candidate's class based on the candidate information;
identifying a particular candidate's class, and;
including all jobs applied by other candidates in the same class in the potential job pool.

11. The recommender method of claim 1, wherein the step of generating the potential job pool comprises:
classifying all employers according to employer information in industry, company size, company type, and public/private categories;
generating a classification rule which can be used to identify a particular employer's class based on employer information;
identifying the class of an employer which a particular candidate applied for, and;
including all jobs from other employers in the same class in the potential job pool.

12. The recommender method of claim 1, wherein the step of generating the potential job pool comprises:
classifying all jobs according to job information in all categories;
generating a classification rule which can be used to identify a particular job's class based on job information;
identifying the class of a job which a particular candidate applied for, and;
including all other jobs in the same class in the potential job pool.

13. A recommender method for recommending candidates for a job posted by an employer, comprising the steps of:
collecting and storing candidate personal information;
collecting and storing information for the job and the employer;
generating a potential candidate pool for the job posted by the employer;
calculating a match degree between the job and a candidate within the potential candidate pool;
sorting candidates in the potential candidate pool according to their match degrees; and
recommending those candidates with a match degree higher than a predetermined minimal match degree.

14. The recommender method of claim 13, wherein the match degree with N dimensions and each dimension having equal to or less than M categories is defined as:
Match Degree=[(Match Degree for 1^{st} dimension×Weight of 1^{st} dimension+Match Degree for 2^{nd} dimension×Weight of 2^{nd} dimension+ . . . +Match Degree for N^{th} dimension×Weight of N^{th} dimension)/M]×100%;
where the sum of Weights of all dimensions is 1, and each Weight is a number in the range from 0 to 1.

15. The recommender method of claim 14, wherein the match degree for each dimension is defined as:
Match Degree for 1^{st} dimension=(Sum of Match Degrees for all involved categories within 1^{st} dimension/the number of categories involved within 1^{st} dimension)×M
where the match degree for each category is in the range from 0 to 1, and “involved” means a particular category is required or mentioned by either the candidate or the job, and every category includes both candidate information and job information, and the match degree for each dimension is a number in the range from 0 to M.

16. The recommender method of claim 14, wherein N equals to 3; three dimensions are classified as: job match, company match, and personality match; the match degree is calculated defined as follows:
Match Degree=[(Job Match Degree×Weight of Job Match+Company Match Degree×Weight of Company Match+Personality Match Degree×Weight of Personality Match)/M]×100%.

17. The recommender method of claim 14, wherein M equals to 10; the job match is classified as ten categories: major, industry, job level, salary range, travel percentage, experience length, certificates, skills, languages, and keywords; the company match is classified as three categories: company size, company type, and public/private; the personality match is classified as ten categories: creative, cooperative, detail-oriented, expressive, leadership, multi-tasks management, patient, risk taker, sociable, and self-motivated; the match degree for each category is calculated as:
(i) for major, industry, and keywords categories, if candidate information and job information overlap, the match degree for the category is 1; or it is 0;
(ii) for job level and salary range categories, if job information matches candidate information, the match degree for the category is 1; otherwise it is 0;
(iii) for experience length and travel percentage categories, if candidate information matches job information, the match degree for the category is 1; or it is 0;
(iv) for certificates, skills, and languages categories, the match degree is defined as:
Match Degree for a particular category=(Number of required certificates/skills/languages possessed by candidates)/(Number of required certificates/skills/languages)
(v) for all company match categories and personality match categories, if candidate information is the same as job information, the match degree for the category is 1; or it is 0.

18. The recommender method of claim 13, wherein the step of generating the potential candidate pool uses K-nearest Neighbors method.

19. The recommender method of claim 13, wherein the step of generating the potential candidate pool comprises:
screening candidates in a candidate database to pick out candidates viewed for the job by the employer;
calculating an average accepted ratio, wherein the average accepted ratio equals to the ratio of number of candidates accepted by the employer for the job over number of candidates viewed by the employer for the job;
calculating similarity between an unviewed candidate and the candidates viewed by the employer;
selecting a predetermined number (K) of nearest viewed candidates to the unviewed candidate;
calculating an estimated accepted ratio based on the selected nearest viewed candidates, wherein the estimated accepted ratio equals to ratio of number of nearest candidates accepted by the employer for the job over K;
including the unviewed candidate in the potential candidate pool if the estimated accepted ratio is equal to or higher than the average accepted ratio.

20. The recommender method of claim 19, wherein the similarity (D_{(X}^{→}_{Y)}) of candidate X to candidate Y and the similarity (D_{(Y}→_{X)}) of candidate Y to candidate X is calculated, respectively, as follows:
D_{(X}→_{Y)}=Σ[d_{(Ax, Ay)}²+d_{(Bx}→_{By)}²+d_{(Cx,} c_{y)}²] and
D_{(Y}→x₎=Σ[d_{(Ax, Ay)}²+d_{(By}→_{Bx)}²+d_{(Cx,} c_{y)}²]
where (i) for incalculable single-choice category A, Aₓ=(aₓ) and A_{y}=(a_{y}), the distance between Aₓ and A_{y} is defined as: d_{(Ax, Ay)}=0 if aₓ=a_{y}; d_{(Ax}→_{A}_{y)}=1 if aₓ≠a_{y};
(ii) for incalculable multi-choice category B, Bₓ=(b_{x1,} b_{x2,} b_{x3,} . . . bₓₘ) and B_{y}=(b_{y1,} b_{y2,} b_{y3,} . . . b_{yn}), the subset Z={z₁, z₂, z₃, . . . zᵢ} includes all common items between Bₓ and B_{y}, the distance of Bₓ to B_{y} is defined as: d_{(Bx}→_{By)}=i/n, and the distance of B_{y} to Bₓ is defined as: d_{(By}→_{Bx)}=i/m.
(iii) for calculable single-choice category C, Cx=(cₓ) and Cy=(c_{y}), the range of C is r, the distance between Cx and Cy is defined as: d(cₓ, c_{y})=|x−y|/r.
(iv) the distance range for all category is 0 to 1, and the distance range for two jobs with k number of categories is 0 to k.

21. The recommender method of claim 13, wherein the step of generating the potential candidate pool uses Classification Tree method.

22. The recommender method of claim 13, wherein the step of generating the potential candidate pool comprises:
classifying all employers according to employer information in industry, company size, company type, and public/private categories;
generating a classification rule which can be used to identify a particular employer's class based on employer information;
identifying the class of the employer who post the job, and;
including all candidates accepted by other employers in the same class in the potential candidate pool.

23. The recommender method of claim 13, wherein the step of generating the potential candidate pool comprises:
classifying all jobs according to job information in all categories;
generating a classification rule which can be used to identify a particular job's class based on job information;
identifying the class of a job which a particular employer post, and;
including all candidates accepted by other jobs in the same class in the potential candidate pool.

24. A pay-for-performance payment method for charging an employer for receiving recommendations of qualified candidates for a job position, comprising the steps of:
providing a fee table which identifies unit cost for receiving recommendation for a qualified candidate under different scales;
requiring the employer to identify desired candidate amount and required minimal match degree when publishing a job posting;
calculating a total fee under the assumption that all candidates recommended are qualified, and charging the employer in advance;
calculating the number of qualified candidates received by the employer after the job posting is closed.
refunding for those unqualified candidates.
